(19) United States
(12) Patent Application Publication
(10) Pub. No.: US 2005/0159328 A1
(43) Pub. Date: Jul. 21, 2005

(54) Liquid coacting bleaching and detergent formulations

(76) Inventors: Michael Oberlander, Kansas City, MO (US); Robert P. Langguth, Overland, MO (US); Patrick Dierker, Kansas City, MO (US)

Correspondence Address: Hovey Williams LLP;Suite 400, 2405 Grand Boulevard, Kansas City, MO, 64108, US

(21) Appl. No.: 10/762,841

(22) Filed: Jan. 21, 2004

(51) Int. Cl. C11D 3/00

(52) U.S. Cl. 510/375

(57) ABSTRACT

A liquid, two-phase bleaching and detergent formulation including a first component having an activator capable of forming a per-acid in the presence of oxygen, and a second component comprising a peroxide compound. Generally, the activator compound is substantially insoluble in water, and a rheology modifier is used to suspend the activator in the first component. When mixed together, the activator and peroxide react to form a per-acid. The second component may also include a peroxide stabilizing system to prevent the degradation of the peroxide prior to mixing the first and second components.

### BACKGROUND OF THE INVENTION

1. Field of the Invention

The present invention is generally directed toward liquid bleaching and detergent formulations. The formulations are prepared as separate phases: a first phase including an oxygen bleaching activator capable of forming a per-acid which is suspended using a rheology modifier, such as a gum, and a second phase including a peroxygen compound such as a peroxide. The activator and peroxygen compound react to form a per-acid when the phases are mixed together.

2. Description of the Prior Art

Bleaching agents have been widely used as an adjunct to detergents for household and industrial dishwashing, laundering, and general hard surface cleaning applications, because of the improved cleaning results that are directly attributable to the use of bleaching compositions. There are two major classes of bleaching agents commonly employed in existing detergent compositions-chlorine-based and oxygen-based (hereinafter referred to as peroxygen). Recently, chlorine-based bleaching agents have come under adverse public scrutiny because of contaminating toxic residues which are generated by their use. Peroxygen bleaching agents, however, are essentially safe and non-toxic and do not present significant environmental hazards.

Bleach activators have been used to improve the bleaching efficiency of peroxygen bleaching agents at lower temperatures. It has been suggested that the bleach activator reacts with the peroxygen bleaching agent in the presence of water to form a per-acid that exhibits properties of a strong oxidant. While being an excellent oxidizing agent, the per-acid is not very shelf-stable. Therefore, in order to provide a single system employing both a peroxygen bleaching agent and a bleach activator, an anhydrous powdered mixture of bleaching agent and activator must have been provided such as that disclosed in U.S. Pat. No. 5,981,463.

In certain applications, it is highly desirable for the bleaching and detergent system to be in liquid form. A preferred bleach activator is tetraacetylethylenediamine (TAED). TAED reacts with hydrogen peroxide to form peracetic acid. However, TAED is relatively insoluble in water. Therefore, there is a real and unfulfilled need in the art to provide a shelf-stable liquid bleaching and detergent system capable of in situ generation of a per-acid from the reaction of a peroxygen bleaching agent and a bleach activator.

### SUMMARY OF THE INVENTION

The present invention overcomes these problems by providing a bleaching and detergent system comprising two coacting, aqueous components. The first aqueous component includes an oxygen bleaching activator capable of forming a per-acid with oxygen and a rheology modifier. The activator and the rheology modifier form a stable suspension in the first component. The second aqueous component includes a peroxygen compound such as a peroxide and a peroxide stabilizer. Upon mixing of the two components, the activator and peroxide react to form a per-acid, preferably peracetic acid. Peracetic acids are generally stronger oxidants than the respective peracetic anions and are effective oxidizing agents and broad spectrum biocides. Also, in situ generation of the peracetic acid avoids stability problems associated with the storage of a pre-formulated peracetic acid solution and provides a more effective bleaching and detergent system.

The oxygen bleaching activator of the first aqueous component is preferably in the form of a powder. Suitable activators include any compound which is capable of forming a per-acid with oxygen in solution and are preferably selected from the group consisting of sodium p-acetoxybenzenesulfonate, trisacetylcyanurate, acetylimidazole, benzoylimidazole, tetraacetylethylenediamine (TAED), and mixtures thereof, with TAED being especially preferred. Preferably, the activator is present in the first aqueous component at a level of from about 1-40% by weight, more preferably from about 1-15% by weight, and most preferably 4-8% by weight, based on the weight of the first aqueous component.

The rheology modifier is generally present in the first aqueous component at a level of from about 0.1-20% by weight and more preferably from about 0.2-0.5% by weight, based on the weight of the first aqueous component. The preferred rheology modifiers are polysaccharide gums including substituted and unsubstituted xanthan gums, guar gums, welan gums, and mixtures thereof. Xanthan gum, particularly that manufactured under the trade names RHODAGEL EZ and RHODOPOL available from Rhodia, Inc., Cranbury, N.J., is most preferred. It is important that any rheology modifier used is not destabilized by the other ingredients in the formulation.

The first aqueous component also preferably includes a surfactant and a phosphate builder. Any anionic or nonionic surfactant is suitable for use with the invention. Preferred anionic surfactants are selected from the group consisting of alkali metal alkylbenzene sulfonates, alkali metal alkyl ether sulfonates, alkali metal alkyl sulfates, alkali metal alpha olefin sulfonates, alkali alkane sulfonates, and mixtures thereof. Preferred nonionic surfactants are selected from the group consisting of polyethylene oxide condensates of alkylphenols, polyethylene oxide condensates of primary or secondary alcohols, polyoxyethylene condensates of a hydrophobic polypropyleneoxide/propylene glycol condensate, alkyl polyglucosides, alkyl amine oxides, and mixtures thereof. Alkyl phenol ethoxylates and alkylated alcohol ethoxylates are preferred. Long-chain fatty acid ethoxylates are also suitable for use with the present invention. Preferably, the surfactant is present at a level of from about 1-40% by weight, and more preferably from about 4-8% by weight, based on the weight of the first aqueous component.

The phosphate builder, preferably used as a 60% solution, functions as an electrolyte and water softening agent and preferably is present in the first aqueous component at a level of from about 3-50% by weight, and more preferably from about 32-40% by weight. Preferred phosphate builders include alkali metal salts of orthophosphoric acid, pyrophosphoric acid, tripolyphosphoric acid, and mixtures thereof. More preferably, the phosphate builder is selected from the group consisting of monosodium and monopotassium orthophosphate, tetrasodium or tetrapotassium pyrophosphate, tetrasodium or tetrapotassium acid pyrophosphate, sodium or potassium tripolyphosphate, and mixtures thereof. Tetrapotassium pyrophosphate (TKPP) is the most preferred phosphate builder. Amounts of sodium tripolyphospate (STPP) or potassium tripolyphosphate (KTPP) may also be used to supplement the TKPP when lesser amounts of TKPP are used.

The first aqueous component may also comprise a number of optional ingredients such a enzymes, enzyme stabilizers and fluorescent whitening agents. Protease enzymes, such as ALCALASE, ESPERASE, SAVINASE and EVERLASE available from Novazymes, Franklinton, N.C., are particularly preferred enzymes for use with the present invention. Propylene glycol and borax are preferred enzyme stabilizers. Tinopal CBS (a distyrylbiphenyl derivative from Ciba-Geigy) is a preferred whitening agent, however any optical brightener suitable for laundry purposes is acceptable and preferably provided in powder form. Suitable whitening agents also include Tinopal 5BM-GX and Tinopal AMS-GX (both are cyanuric chloride/diaminostilbene disulfonic acids made by Ciba-Geigy).

The peroxide of the second aqueous component preferably comprises a 35% solution of hydrogen peroxide and is present at a level of from about 1-40% by weight, and more preferably from about 4-6% by weight based on the weight of the second aqueous component. A sufficient amount of peroxide should be provided to assure that when the peroxide reacts with the activator, an adequate amount of peracetic acid is formed for a particular application of the formulation. The specific amount of peroxide used depends largely upon the amount of oxygen bleaching activator used as it is preferable to have a 100% excess of peroxide relative to the activator in order to carry out the reaction forming the per-acid. When carried out under preferred conditions, the reaction yields a per-acid concentration of from about 20-100 ppm.

A peroxide stabilizer is employed in order inhibit degradation of the peroxide and increase the shelf-life of the second aqueous component. Preferably, the peroxide stabilizer is present in the second aqueous component at a level of from about 0.1-10% by weight, and preferably from about 0.5-1.5% by weight based on the weight of the second aqueous component. Phosphonic acids and salts thereof are preferred peroxide stabilizers with 1-hydroxyethylene-1,1-phosphonic acid (DEQUEST 2010 available from Solutia, Inc., St. Louis, Mo.) or a salt thereof being most preferred. If the acidic species of the peroxide stabilizer is employed, it is preferable to neutralize the acid by the addition of a sufficient amount of caustic soda or potash so that the pH of the second aqueous component is in the range of about 7-11. If the salt species of the peroxide stabilizer is employed, no caustic soda or potash is required.

The second aqueous component may also include a phosphate stabilizing agent which acts to further increase the stability of the peroxide. Preferred stabilizing agents comprise an alkali metal phosphate salt, and even more preferably comprise sodium tripolyphosphate (STPP). The STPP is preferably a light-density grade for rapid solubility in the second aqueous component. Preferably, the phosphate stabilizing agent is present at a level of from about 1-20% by weight, and more preferably from about 4-8% by weight, based on the weight of the second aqueous component.

### DETAILED DESCRIPTION OF THE PREFERRED EMBODIMENTS

The following examples set forth bleaching and detergent formulations and methods of making the same according to the invention. It is to be understood, however, that these examples are provided by way of illustration and nothing therein should be taken as a limitation upon the overall scope of the invention.

### EXAMPLE 1

Preferred co-acting bleaching and detergent formulations according to the invention comprise two separate phases (Phases A and B) that are mixed together at the point of use. This example describes the method of making a preferred Phase A formulation.

The following table sets forth the amounts of ingredients used in the Phase A formulation.

TABLE 1

| Ingredient | Amount (lbs.) |
|---|---|
| Water | 49.975 |
| Tetrapotassium pyrophosphate (TKPP) | 38.00 |
| Xanthan gum (Rhodagel EZ) | 0.30 |
| Tetraacetylethylenediamine (TAED) | 5.00 |
| Fluorescent whitening agent (BRY-10) | 0.35 |
| Propylene glycol | 0.50 |
| Borax | 0.50 |
| Protease enzyme | 0.375 |
| Surfactant (Makon 10) | 5.00 |

The tetrapotassium pyrophosphate is added to cold water and mixed for 3-5 minutes until homogeneous. Next, the xanthan gum is slowly sifted into the aqueous dispersion. The composition is mixed for 30-45 minutes until no xanthan gum lumps are observed. Powdered TAED is added and the dispersion mixed for approximately 5 minutes or until no lumps are observed. The fluorescent whitening agent, propylene glycol, borax, and protease enzyme are sequentially mixed in, and the entire composition mixed for an additional 5 minutes. Finally, the surfactant is added and the composition mixed for 5-10 minutes. Mixing should continue until the TAED appears powdery and the mix is opaque. The entire mixture is passed through a homogenizer and then packaged in plastic containers. It has been discovered that the step of passing the mixture through the homogenizer not only improved the storage life of the product, but also increased the temperature stability to about 50° C.

### EXAMPLE 2

This example describes the method of making a preferred Phase B formulation. The following table sets forth the amounts of ingredients used in the Phase B formulation.

TABLE 2

| Ingredient | Amount (lbs.) |
|---|---|
| Water, deionized or distilled | 79.55 |
| Sodium tripolyphosphate, light density (STPP) | 7.00 |
| Phosphoric acid stabilizing agent (DEQUEST 2010) | 0.50 |
| Caustic soda (50%) | 0.30 |
| Hydrogen peroxide (35%) | 12.65 |

The deionized or distilled water is placed in a dry, clean mixer and is agitated. The STPP is added to the mixer and dissolved. Then, the caustic soda is added and stirred until even dissolved. The DEQUEST 2010 is added and mixed until dissolved. At this point, the pH of the solution is measured and should be in the range of 7-11. If the pH is not within this range, additional caustic soda or DEQUEST 2010 may be added as necessary until the pH is acceptable. Once the pH is within the acceptable range, the hydrogen peroxide is added and the solution mixed until homogenous. Finally, the solution is placed in plastic containers.

### EXAMPLE 3

This example describes a method of using the detergent and bleaching formulations, Phases A and B, in a laundry. Approximately 2-3 oz. of each of Phases A and B is added at the start of a laundry cycle using a fifty (50) pound commercial laundry machine. If a larger machine is used, the amount of Phases A and B used should be scaled up accordingly. The temperature of the water is at least 120° F., however bleaching does occur at lower temperatures. The laundry machine continues operation through the various washing cycles.

The following table summarize broad and preferred ranges given in weight percentage based on the weight of each phase for the components the inventive formulation. The weight percentages for the ingredients of Phase A are based on the weight of Phase A only, and likewise, the weight percentages for the ingredients of Phase B are based on the weight of Phase B only.

TABLE 3

| | Broad range | Preferred range |
|---|---|---|
| Ingredient | (wt. %) | (wt. %) |
| Phase A | | |
| Activator | 1-40 | 4-8 |
| Surfactant | 1-40 | 4-8 |
| Phosphate builder, | 3-50 | 20-28 |
| as solid TKPP | | |
| Rheology modifier | 0.1-20 | 0.2-0.5 |
| Fluorescent whitening agent | 0.1-5 | 0.1-0.5 |
| Enzyme | 0.1-10 | 0.1-0.5 |
| Enzyme stabilizer | 0.1-10 | 0.5-2.0 |
| Water | q.s. | q.s. |
| Phase B | | |
| Peroxide bleach, | 1-40 | 4-6 |
| as 35% solids | | |
| Bleach stabilizer, | 0.1-10 | 0.5-1.5 |
| as 50% solids | | |
| Phosphate stabilizing agent | 1-20 | 4-8 |
| Water | q.s. | q.s. |

1. A bleaching and detergent system comprising:
a first aqueous component including an oxygen bleaching activator capable of forming a per-acid with oxygen and a rheology modifier, said activator and said modifier forming a suspension in said first aqueous component; and
a second aqueous component including a peroxide and a peroxide stabilizer.

2. Th system of claim 1, wherein said rheology modifier is a polysaccharide gum.

3. The system of claim 2, said polysaccharide gum being selected from the group consisting of substituted and unsubstituted xanthan gums, guar gums, welan gums, and mixtures thereof.

4. The system of claim 1, said first aqueous component further comprising a surfactant and a phosphate builder.

5. The system of claim 4, said surfactant being selected from the group consisting of anionic or nonionic surfactants.

6. The system of claim 5, said surfactant being selected from the group consisting of alkali metal alkylbenzene sulfonates, alkali metal alkyl ether sulfonates, alkali metal alkyl sulfates, alkali metal alpha olefin sulfonates, alkali alkane sulfonates, polyethylene oxide condensates of alkylphenols, polyethylene oxide condensates of primary or secondary alcohols, polyoxyethylene condensates of a hydrophobic polypropyleneoxide/propylene glycol condensate, alkyl polyglucosides, alkyl amine oxides, and mixtures thereof.

7. The system of claim 6, said surfactant comprising alkyl phenol ethoxylate.

8. The system of claim 4, said phosphate builder being selected from the group consisting of alkali metal salts of orthophosphoric acid, pyrophosphoric acid, tripolyphosphoric acid, and mixtures thereof.

9. The system of claim 1, said first aqueous component comprising from about 1-40% by weight activator based on the weight of the first component.

10. The system of claim 1, said first aqueous component comprising from about 0. 1-20% by weight modifier based on the weight of the first component.

11. The system of claim 1, said activator being selected from the group consisting of sodium p-acetoxybenzenesulfonate, trisacetylcyanurate, acetylimidazole, benzoylimidazole, tetraacetylethylenediamine, and mixtures thereof.

12. The system of claim 1, said second aqueous component comprising from about 1-40% by weight of a 35% solution of a peroxide based on the weight of the second component.

13. The system of claim 1, said peroxide comprising hydrogen peroxide.

14. The system of claim 1, said second aqueous component comprising from about 0.1-10% by weight peroxide stabilizer based on the weight of the second component.

15. The system of claim 1, said peroxide stabilizer comprising a phosphonic acid or salt thereof.

16. The system of claim 1, said second aqueous component further including a phosphate stabilizing agent, said stabilizing agent comprising an alkali metal phosphate salt.

17. The system of claim 1, said first aqueous component further comprising one or more ingredients selected from the group consisting of protease enzymes, fluorescent whitening agents, and enzyme stabilizers.

18. A bleaching and detergent system comprising:
a first aqueous component including
from about 1-40% by weight of an oxygen bleaching activator capable of forming a per-acid with oxygen,
from about 1-40% by weight of a surfactant,
from about 3-50% by weight of a 60% solution of a TKPP phosphate builder, and
from about 0.1-20% by weight of a polysaccharide gum, all based upon the weight of the first aqueous component; and
a second aqueous component including
from about 1-40% by weight of a 35% solution of a peroxide,
from about 0.1-10% by weight of a peroxide stabilizer, and
from about 1-20% by weight of a phosphate stabilizing agent, all based upon the weight of the second aqueous component.

19. The system of claim 18, said surfactant being selected from the group consisting of anionic or nonionic surfactants.

20. The system of claim 19, said surfactant being selected from the group consisting of alkali metal alkylbenzene sulfonates, alkali metal alkyl ether sulfonates, alkali metal alkyl sulfates, alkali metal alpha olefin sulfonates, alkali alkane sulfonates, polyethylene oxide condensates of alkylphenols, polyethylene oxide condensates of primary or secondary alcohols, polyoxyethylene condensates of a hydrophobic polypropyleneoxide/ propylene glycol condensate, alkyl polyglucosides, alkyl amine oxides, and mixtures thereof.

21. The system of claim 20, said surfactant comprising an alkyl phenol ethoxylate.

22. The system of claim 18, said activator being selected from the group consisting of sodium p-acetoxybenzenesulfonate, trisacetylcyanurate, acetylimidazole, benzoylimidazole, tetraacetylethylenediamine, and mixtures thereof.

23. The system of claim 18, said polysaccharide gum being selected from the group consisting of substituted and unsubstituted xanthan gums, guar gums, welan gums, and mixtures thereof.

24. The system of claim 18, said peroxide comprising hydrogen peroxide.

25. The system of claim 18, said peroxide stabilizer comprising a phosphonic acid or salt thereof.

26. The system of claim 18, said phosphate stabilizing agent comprising an alkali metal phosphate salt.

27. The system of claim 18, said first aqueous component further comprising one or more ingredients selected from the group consisting of protease enzymes, fluorescent whitening agents, and enzyme stabilizers.

28. A method of preparing a bleaching and detergent system comprising the steps of:
forming a first aqueous phase by combining a quantity of water with an oxygen bleaching activator capable of forming a per-acid with oxygen, and a rheology modifier, said activator and said modifier forming a suspension in said first aqueous phase;
forming a second aqueous phase by combining a quantity of water with a peroxide and a peroxide stabilizer,
said first and second aqueous phases kept separated from each other prior to usage of said bleaching and detergent system.

29. The method of claim 28, said method including the step of combining said first and second aqueous phases upon usage of said bleaching and detergent system.

30. The method of claim 28, said first aqueous component further comprising a surfactant and a phosphate builder.

31. The method of claim 30, said surfactant being an anionic or nonionic surfactant selected from the group consisting of alkali metal alkylbenzene sulfonates, alkali metal alkyl ether sulfonates, alkali metal alkyl sulfates, alkali metal alpha olefin sulfonates, alkali alkane sulfonates, polyethylene oxide condensates of alkylphenols, polyethylene oxide condensates of primary or secondary alcohols, polyoxyethylene condensates of a hydrophobic polypropyleneoxide/propylene glycol condensate, alkyl polyglucosides, alkyl amine oxides, and mixtures thereof.

32. The method of claim 31, said surfactant comprising alkyl phenol ethoxylate.

33. The method of claim 30, said phosphate builder being selected from the group consisting of alkali metal salts of orthophosphoric acid, pyrophosphoric acid, tripolyphosphoric acid, and mixtures thereof.

34. The method of claim 28, said activator being selected from the group consisting of sodium p-acetoxybenzenesulfonate, trisacetylcyanurate, acetylimidazole, benzoylimidazole, tetraacetylethylenediamine, and mixtures thereof.

35. The method of claim 28, said rheology modifier comprising a polysaccharide gum.

36. The method of claim 35, said polysaccharide gum being selected from the group consisting of substituted and unsubstituted xanthan gums, guar gums, welan gums, and mixtures thereof.

37. The method of claim 28, said peroxide comprising hydrogen peroxide.

38. The method of claim 28, said peroxide stabilizer comprising aphosphonic acid or salt thereof.

39. The method of claim 28, said second aqueous component further including a phosphate stabilizing agent, said stabilizing agent comprising an alkali metal phosphate salt.

40. The method of claim 28, said first aqueous component further comprising one or more ingredients selected from the group consisting of protease enzymes, fluorescent whitening agents, and enzyme stabilizers.
